(19) United States
(12) Patent Application Publication
(10) Pub. No.: US 2017/0241623 A1
(43) Pub. Date: Aug. 24, 2017

(54) PROJECTOR LAMP

(71) Applicant: Zaixing Electronic (Shenzhen) Co., Ltd., Shenzhen (CN)

(72) Inventor: Cheng-Chun ZHANG, Shenzhen (CN)

(73) Assignee: Zaixing Electronic (Shenzhen) Co., Ltd., Shenzhen (CN)

(21) Appl. No.: 15/168,651

(22) Filed: May 31, 2016

(30) Foreign Application Priority Data
Feb. 19, 2016 (CN) 201610092661.0

(51) Int. Cl. F21V 14/06; F21V 23/00; F21V 5/04; F21V 31/00; F21V 5/00; F21V 23/02; F21V 23/04

(52) U.S. Cl. CPC F21V 14/06; F21V 23/02; F21V 23/005; F21V 23/04; F21V 31/005; F21V 5/007; F21V 5/045

(57) ABSTRACT

A projector lamp, comprising a hollow lamp housing having an opening formed at the first end thereof; a power supply adaptor, mounted within the lamp housing and in communication with an external power supply via a second end of the lamp housing; a lighting module, mounted inside the lamp housing and comprising a circuit board and a plurality of light emitting diode units, the circuit board being electrically connected with the power supply adaptor, and the plurality of light emitting diode units being electrically mounted on the circuit board to emit light when the projector lamp is energized; a lens, mounted at the opening of the lamp housing such that light emitted by the plurality of light emitting diode units projects out therethrough; and an adjusting assembly, having an adjusting ring and a controller, the adjusting ring being mounted on the outer periphery of the lamp housing around a longitudinal axis of the lamp housing extending from the first end to the second end thereof.

### TECHNICAL FIELD

The present application relates to a projector lamp.

### BACKGROUND

Projector lamps are generally used in sites such as stages to produce fantasy lighting atmosphere. The existing projector lamp generally comprises a motor and a light projection part, wherein the light projecting part generally comprises a lamp housing, a lighting module and a lens. The lighting module and lens are both mounted on the lamp housing, and the lighting module emits light towards the lens. The motor may drive the projector lamp to rotate or swivel to produce various lighting effects.

However, once installed, the existing projector lamp can often merely produce predetermined lighting effect by rotating the motor or swiveling the lamp to different positions. In operation, such a projector lamp can merely produce light in fixed and predetermined patterns; the lighting effect is monadic, and a real time adjustment in accordance with the field situation is not possible.

Thus, it is desirable to provide an improved projector lamp which can easily adjust the lighting mode in accordance with the field situations.

### SUMMARY OF THE INVENTION

To solve the abovementioned problems, there provides a new projector lamp in this application, which comprises:

a hollow lamp housing, having an opening formed at a first end thereof; a power supply adaptor, mounted inside said lamp housing and in communication with an external power supply via a second end of said lamp housing;

a lighting module mounted within said lamp housing and having:
a circuit board electrically connected with said power supply adaptor;
a plurality of light emitting diode units, electrically mounted on said circuit board to emit light when said projector lamp is energized;

a lens, mounted at the opening of said lamp housing so that light emitted by said plurality of light emitting diode units projects out therethrough;

an adjusting assembly, comprising:
an adjusting ring, mounted on the outer periphery of said lamp housing around a longitudinal axis of said lamp housing extending from the first end to the second end of said lamp housing, and rotatable around said longitudinal axis,
a controller, mounted within said lamp housing, electrically connected with said lighting module and coupled to said adjusting ring, wherein when said adjusting ring is rotated, said controller adjusts the lighting mode of said plurality of light emitting diode units in response to the rotation of said adjusting ring.

By the adjusting assembly having an adjusting ring mounted on the outer periphery of the lamp housing, an operator may easily adjust the lighting mode of light emitting diode units within said projector lamp near a projector lamp, so as to conveniently adjust the lighting mode of the projector lamp per se. For example, with the adjusting assembly, an operator can easily adjust the lightness, color etc. of the light emitted from the projector lamp directly in the proximity of the lamp housing. An operator can adjust the light color through the adjusting assembly by rotating the adjusting ring, to obtain different lighting effects, such as kaleidoscope, starry night, icing-cloud, firing-cloud etc.

In an alternative, said adjusting assembly further comprises an adjusting lever disposed between said adjusting ring and said controller and engaged with them. The rotation of said adjusting ring may induce the motion of said adjusting lever, so as to actuate a controlling switch disposed on said controller, causing said controller to adjust the lighting mode of said plurality of light emitting diode units.

In an alternative, said adjusting ring is bi-directionally rotatable around said longitudinal axis. By means of the bidirectional rotations, the lighting mode of the projector lamp can be adjusted reversibility.

In an alternative, said adjusting lever comprises a first side leg, a second side leg and an intermediate leg, wherein said first side leg and second side leg are symmetrical about said intermediate leg, and the adjusting lever is pivotably mounted on the inner wall of said lamp housing between said first side leg and second side leg and at the first end of said intermediate leg, so that it is pivotable around an adjusting pivot running parallel to the longitudinal axis of said lamp housing. Said first side leg and second side leg are engaged with a first controlling switch and a second controlling switch of said controlling switch, respectively, and a second end of said intermediate leg protrude through a slot formed on the wall of said lamp housing to engage said adjusting ring. The rotation of said adjusting ring will actuate the second end of said intermediate leg, making said adjusting lever pivot around said adjusting pivot, causing said first side leg or second side leg to activate said first controlling switch or second controlling switch of said controller.

In an alternative, said adjusting ring comprises a plurality of protrusions which are disposed on the internal periphery of the adjust ring and spaced apart from each other. When said adjusting ring is rotated, said plurality of protrusions will contact the second end of said intermediate leg sequentially, to urge the pivoting motion of said adjusting lever.

In an alternative, said adjusting ring is disposed in a recess formed on the outer periphery of said lamp housing, with the outer periphery of said adjusting ring and the outer periphery of said lamp housing merging smoothly, to form a continuous external surface, achieving a substantially smooth and streamlined outer profile of the lamp housing.

In an alternative, the outer periphery of said adjusting ring is provided with certain surface features for the ease of grasping.

In an alternative, said adjusting ring is disposed between the opening of the lamp housing and the lens. Advantageously, the adjusting ring may be disposed at other positions on the lamp housing outer periphery in accordance with the specific lamp housing configuration or other requirements.

In an alternative, a metallic Screw-type lamp base may be sealingly mounted at the second end of said lamp housing. Such a lamp base may render said projector lamp applicable in any suitable interfaces.

In an alternative, the lamp further comprises a water tight seal disposed between said adjusting assembly and said lamp housing, and/or a water tight seal disposed between said lens and the opening of said lamp housing. The water tight seals may facilitate a water-proof lamp housing, making the lamp applicable outdoors or even under water.

In an alternative, said projector lamp further comprises:

a motor disposed within said lamp housing, on a side of said lighting module that is distal to said opening, said motor being electrically connected with said power supply adaptor and having a motor shaft extending toward said opening; said circuit board having a circuit board opening, with said motor passing through said circuit board opening without contacting said circuit board; and a multi-surface refractive lens, secured around said motor shaft and disposed within said lamp housing between said lighting module and said opening, said multi-surface refractive lens having a plurality of multi-angle refractive convex-lenses formed on a surface of said multi-surface refractive lens which is distal from said lighting module.

In an alternative, the projector lamp lens is a beam-splitter lens, and has a plurality of multi-angle refractive convex-lens, which are formed on a surface of said beam-splitter lens facing said multi-surface refractive lens.

In both of the preceding alternatives, via said motor and the multi-surface refractive lens disposed within the lamp housing, light beams emitted by the light emitting diode units can diverge at various angles through the refraction of the multi-surface refractive lens, to cover a larger area. The multi-angle refractive convex-lenses of the beam-splitter lens at the lamp opening will further refract out the light passing through the beam-splitter lens, such that the light beams refracted by the beam-splitter lens can diverge outward in various angles to cover a larger area. Meanwhile, with the rotating multi-surface refractive lens and the light emitting diode units flickering with multi-chromatic light beams, the projector lamp can create various excellent lighting effects resembling kaleidoscope, starry night, icing-cloud, firing-cloud etc.

In an alternative, said beam-splitter lens is a semispheric beam-splitter lens.

In an alternative, the projector lamp further comprises an insulating panel mounted between said lighting module and said motor, said insulating panel having a panel orifice, said motor shaft passing through said panel orifice without contacting said panel orifice. With said insulating panel, the motor can be kept from being affected by the high temperature generated by the light emitting diode units in operation.

In an alternative, said lighting module has a memory function, such that when said projector lamp is reenergized after a power interruption, the light emitted through said opening is identical with that before the power interruption.

In an alternative, various characteristics, such as the lightness, light color etc. of said projector lamp can be adjusted by rotating said adjusting ring.

The present application further provides a projector lamp, comprising:

a hollow lamp housing, having an opening formed at a first end thereof;

a power supply adaptor, mounted within said lamp housing and in communication with an external power supply through a second end of said lamp housing;

a lighting module, mounted within said lamp housing, having:
a circuit board, electrically connected with said power supply adaptor;
a plurality of light emitting diode units, electrically mounted on said circuit board to emit light when said projector lamp is energized;

a lens, mounted at the opening of said lamp housing, such that light emitted by said plurality of light emitting diode units projects out therethrough;

an adjusting assembly, having:
an adjusting ring operable to be rotated by an operator,
a controller, coupled to said lighting module and said adjusting ring in a wired or wireless manner, wherein when said adjusting ring is rotated, said controller adjusts the lighting mode of said plurality of light emitting diode units responsive to the rotation of said adjusting ring.

In an alternative of the above projector lamp, said adjusting assembly is positioned distally from said hollow lamp housing.

### BRIEF DESCRIPTION OF THE DRAWINGS

By means of illustration, embodiments of the present application are discussed more fully in the next content with reference to the accompanying drawings, in which:

FIG. 1 is an overall perspective view of one embodiment of the projector lamp according to the present application;

FIG. 2 is a partially cutout view of one embodiment of the projector lamp according to the present application;

FIG. 3 is an explosive view of the projector lamp shown in FIG. 2;

FIG. 4 is a perspective view of the projector lamp shown in FIGS. 2 and 3, with the lens removed;

FIG. 5 is a top view of the projector lamp shown in FIG. 4 with the lens removed;

FIG. 6 is a perspective view one embodiment of an adjusting ring of the projector lamp according to the present application;

FIG. 7 shows the controlling switch and adjusting lever in an embodiment of the adjusting assembly of the projector lamp according to the present application; and

FIG. 8 shows the multi-surface refractive lens and circuit board of one embodiment of the projector lamp according to the present application.

### DETAILED DESCRIPTION OF THE INVENTION

One exemplary embodiment of the present disclosure will be discussed next with reference to the accompanying Drawings, in which like reference numbers are used to indicate like elements. In the following discussion, many details are explained to provide a better and more comprehensive understanding of the present application. Nevertheless, it should be appreciated that the present application may be embodied without these details, and is not limited to the exemplary embodiments disclosed in the present application.

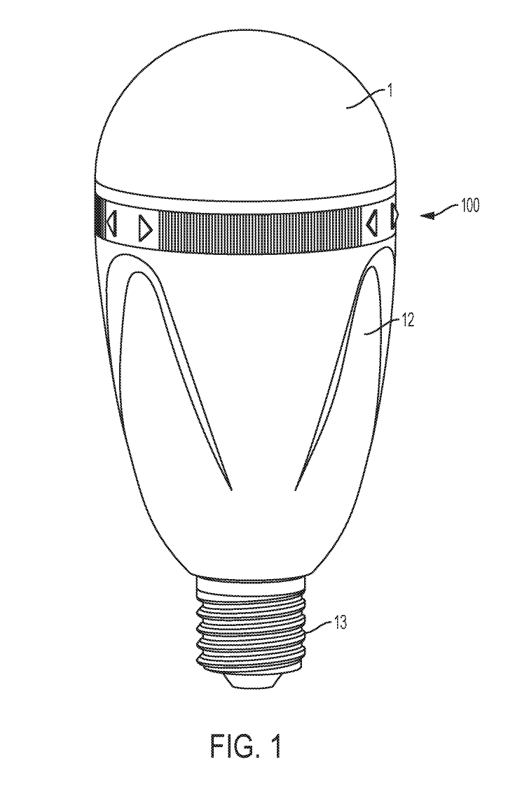

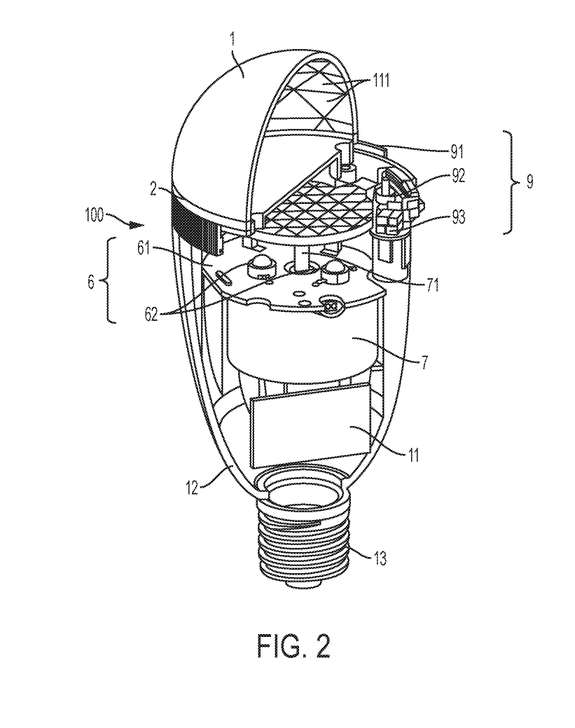

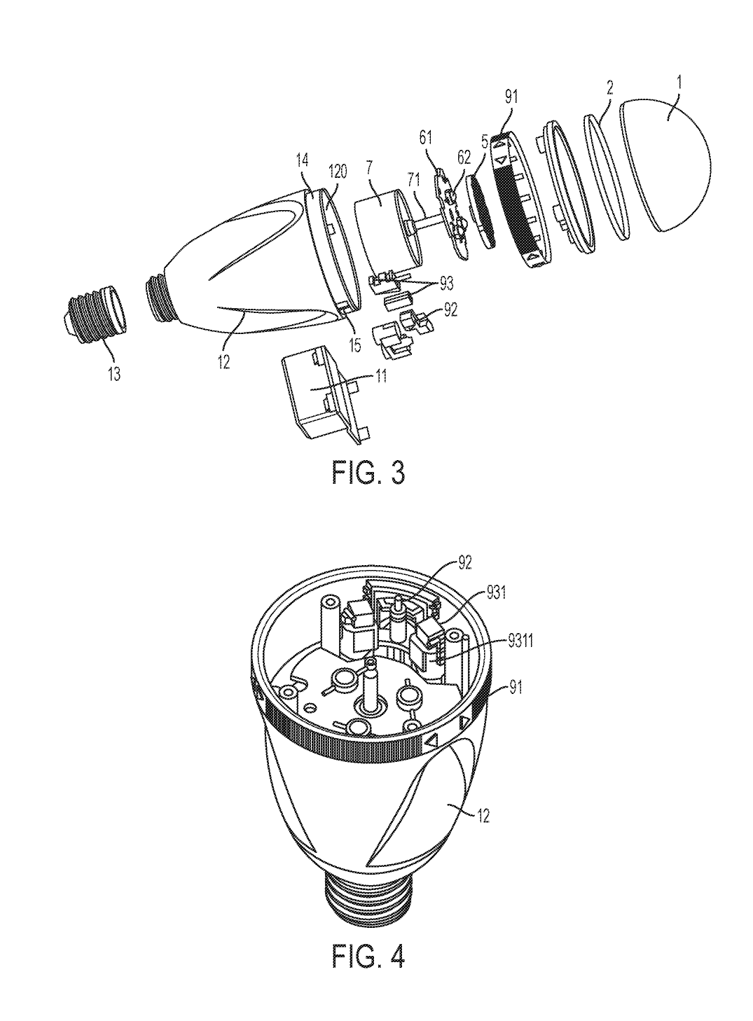

As shown in FIGS. 1 to 3, the present application provides a projector lamp 100 comprising a hollow lamp housing 12, wherein the lamp housing 12 has an opening 120 formed at the first end thereof. A power supply adaptor 11 is mounted inside said lamp housing 12, and is communicated with an external power supply via the second end of said lamp housing 12. A lighting module 6 is mounted inside said lamp housing 12, and has: a circuit board 61 electrically connected with the power supply adaptor 11; and a plurality of light emitting diode units 62, which are electrically mounted on said circuit board 61, so as to emit light when said projector lamp 100 is energized. A lens 1 is mounted at the opening 120 of the lamp housing 12, such that the light emitted by the plurality of light emitting diode units 62 projects out therethrough.

The projector lamp 100 further comprises an adjusting assembly 9, which comprises: an adjusting ring 91, an operator being able to operate said adjusting ring 91 external of said lamp housing 12 to rotate it around a longitudinal axis of the lamp housing 12 extending from the first end to the second end. The adjusting assembly 9 further comprises a controller 93, which is electrically connected with the lighting module 6 and is coupled to the adjusting ring 91, such that when the adjusting ring 91 is rotated, the controller 93 adjusts the lighting mode of the plurality of light emitting diode units 62 in response to the rotation of the adjusting ring 91.

In an embodiment, the adjusting ring 91 is mounted on the outer periphery of the lamp housing 12 around an imaginary longitudinal axis of the lamp housing 12 extending from the first end to the second end of said lamp housing 12.

In an embodiment, a controller 93 is mounted inside the lamp housing 12.

In a preferred embodiment, the adjusting assembly 9 further comprises an adjusting actuator, which mechanically actuates the adjusting motion of the controller 93 in response to the rotation of the adjusting ring 91. The adjusting actuator may be in the form of an adjusting lever 92. The adjusting lever 92 is disposed between the adjusting ring 91 and the controller 93, and is engaged with them; the rotation of the adjusting ring 91 induces a motion of the adjusting lever 92, such that a controlling switch 931 disposed on the controller 93 is actuated, making the controller 93 in turn adjust the lighting mode of the plurality of light emitting diode units 62. In an embodiment, the controlling switch 931 may be secured by a controlling switch fastener 9311, which may be, for example, connected to the inner wall of the lamp housing 12, or formed integrally with the internal of the lamp housing 12. Specifically, by rotating the adjusting ring 91, various characteristics of the projector lamp 100 can be adjusted, such as lightness, light color etc. Such an adjustment can be either continuous or intermittent.

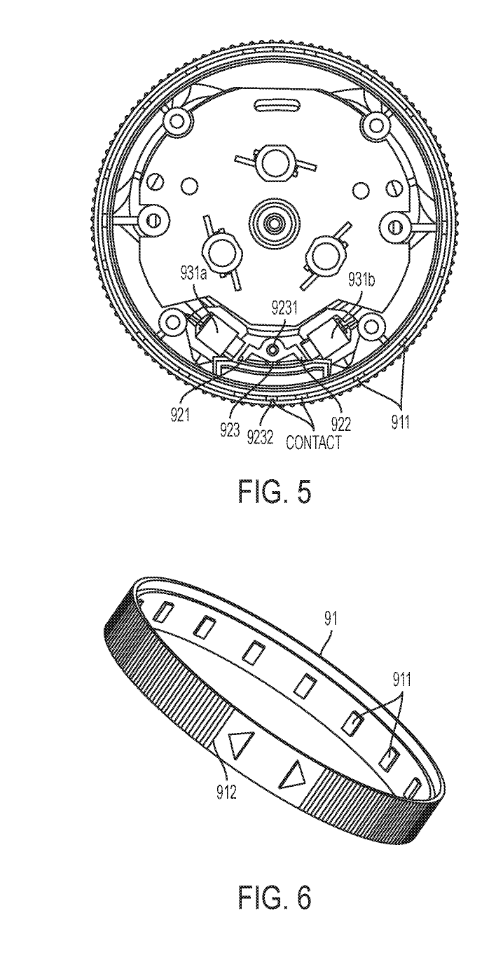

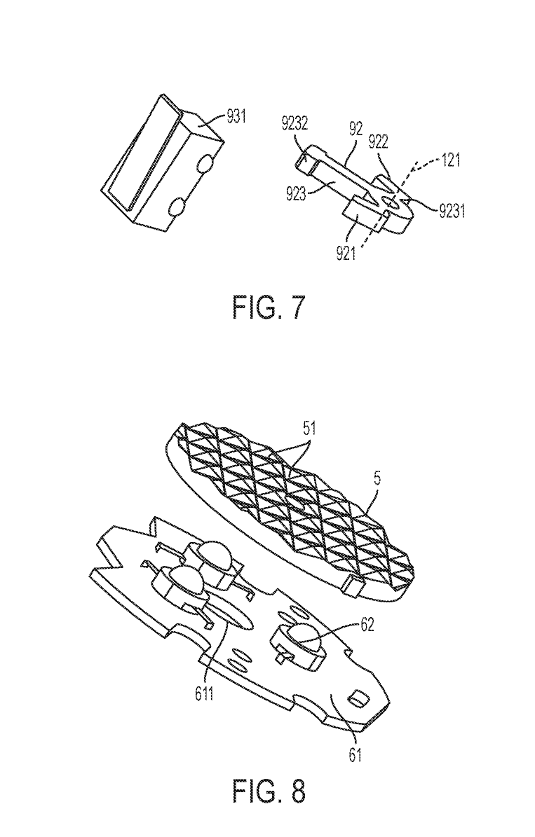

FIGS. 4 and 5 illustrate the configuration of the adjusting assembly 9 more clearly.

In a preferred embodiment, the adjusting ring 91 is rotatable around the longitudinal axis in two directions. With such bidirectional rotations, the lighting mode of the projector lamp 100 can be adjusted reversibly.

The adjusting lever 92 may comprises a first side leg 921, a second side leg 922 and an intermediate leg 923, wherein the first side leg 921 and the second side leg 922 may be symmetrical with respect to the intermediate leg 923, and the adjusting lever 92 is pivotably mounted on the inner wall of the lamp housing 12 between the first side leg 921 and second side leg 922, at a first end 9231 of the intermediate leg 923, such that it can pivot around an adjusting pivot 121 parallel to the longitudinal axis of the lamp housing; wherein the first side leg 921 and second side leg 922 are engaged with a first controlling switch 931a and a second controlling switch 931b in the controlling switch, respectively; the second end 9232 of the intermediate leg 923 protrudes out through a slot 15 formed in the wall of the lamp housing to engage the adjusting ring 91. The rotation of the adjusting ring 91 may actuate the second end of the intermediate leg 923, making the adjusting lever 92 pivot around the adjusting pivot 121, such that the first side leg 921 or second side leg 922 will actuate the first controlling switch 931a or second controlling switch 931b of the controller 93.

In an embodiment, the adjusting ring 91 may comprise a plurality of protrusions 911 disposed on the internal periphery thereof and spaced apart from each other. When the adjusting ring 91 is rotated, the plurality of protrusions 911 will contact the second end 9232 of the intermediate leg 923 sequentially, urging the adjusting lever 92 to pivot.

With the abovementioned configuration of the adjusting ring 91 and adjusting lever 92, the adjusting lever 92 can be mechanically actuated by the rotation of the adjusting ring 91, and said adjusting lever 92 may in turn mechanically actuate respective controlling switch 931a, 931b on the controller 93, making the controller adjust the light emitting diode units 62.

In an embodiment, adjusting ring 91 is disposed in a recess 14 formed on the outer periphery of the lamp housing 12, such that the outer periphery of the adjusting ring 91 and the outer periphery of the lamp housing 12 form a substantially continuous smooth outer surface, achieving a substantially smooth and streamlined outer profile of the lamp housing.

The outer periphery of the adjusting ring 91 may also be provided with surface features 912 for the ease of grasping.

In an embodiment, the adjusting ring 91 is mounted between the opening 120 of the lamp housing and the lens 1.

A metallic Screw-type lamp base 13 may be sealingly mounted at the second end of the lamp housing 12. Such a metallic Screw-type lamp base 13 is configured such that the projector lamp 100 is applicable in any suitable interfaces.

The projector lamp 100 may also comprise a water tight seal disposed between the adjusting assembly 9 and the lamp housing 12, and/or a water tight seal disposed between the lens 1 and the opening 120 of the lamp housing 12. With properly mounted seals, the projector lamp 100 can be water proof, and thus may be applicable outdoors, or even under water.

A motor 7 is mounted within the internal space of the lamp housing 12, which is electrically connected with the power supply adaptor 11, and has a motor shaft 71 facing the opening 120 of the lamp housing 12. A lighting module 6 is mounted in the internal space of the lamp housing 12, in front of the motor 7 (that is, in a direction facing the opening 120 of the lamp housing 12, and around the motor shaft 71. The circuit board 61 is electrically connected with the power supply adaptor 11, and has an orifice 611 formed through the circuit board 61. The circuit board 61 is mounted around the motor shaft 71 by means of the circuit board orifice 611 without contacting the motor shaft 71. The light emitting diode units 62 can emit light beams in different colors, and are electrically mounted on a side of the circuit board 61 distal from the motor 7, or the side opposite the motor 7. The circuit board 61 can control the lighting mode of the light emitting diode units 62, such as flickering mode or normal lighting mode. The power supply adaptor 11 supplies power to the lighting module 6 and the motor 7.

In an embodiment, an insulating panel may be mounted between the lighting module 6 and the motor 7, so as to keep the motor 7 from being affected by high temperatures generated by the light emitting diode units 62 in operation. The insulating panel may be fixed in the lamp housing 12 on a side of the circuit board 61 facing the motor 7, or on a side of the motor 7 facing the circuit board 61. The insulating panel has an panel orifice formed therethrough. The insulating panel is mounted around the motor shaft through said panel orifice, and is fixed on a side of the circuit board 61 facing the motor 7.

A multi-surface refractive lens 5 is rotatably mounted in the internal space of the lamp housing 12 and around the motor shaft 71, and is secured to the motor shaft 71. The multi-surface refractive lens 5 is located in front of the lighting module 6. The multi-surface refractive lens 5 has a plurality of multi-angle refractive convex-lenses 51, which are formed in a front side of the multi-surface refractive lens 5 distal from the lighting module 6. The multi-surface refractive lens 5 can be driven by the motor shaft 71 of the motor 7 to be rotated.

In an embodiment, the lens 1 of the projector lamp 100 is a beam-splitter lens, that is, a beam-splitter lens 1 is mounted at the opening 120 of the lamp housing 12. The beam-splitter lens 1 can be engaged with the lamp housing 12, such as being bonded to the lamp housing 12, or assembled with the lamp housing 12 via threads. The beam-splitter lens 1 can be planar, semispheric, or in other suitable shapes. In case beam-splitter lens 1 is semispheric, it has a plurality of multi-angle refractive convex-lens 111, which are formed on the back side of the semispheric beam-splitter lens 1 facing the multi-surface refractive lens 5.

A water tight gasket 2 can be mounted between the beam-splitter lens 1 and the opening 120 of the lamp housing 12, to prevent water or moisture from entering into the inner space of the lamp housing 12.

In operation, the projector lamp 100 is interfaced with any suitable external power supply interface via a metallic threaded lamp base 13. The power supply adaptor 11 can convert alternating current from the external power supply into direct current, to supply power to the motor 7 and the lighting module 6. The light emitting diode units 62 can emit beams of different colors which pass through the multi-angle refractive convex-lenses 51 of the multi-surface refractive lens 5. Meanwhile, the motor shaft 71 of the motor 7 drives the multi-surface refractive lens 5 to rotate. When light is projected through the multi-surface refractive lens 5, the light will be further refracted and further mixed to form light beams of different colors.

Light beams (homogeneous light or polychromatic light) further pass through the multi-angle refractive convex-lenses 111 of the beam-splitter lens 1, and are further refracted outward through the beam-splitter lens 1. Light beams refracted via the beam-splitter lens 1 can project out in various angles to cover a larger area. Meanwhile, by means of the rotating multi-surface refractive lens 5 and the light emitting diode units 62 flickering in light beams of different colors, the projector lamp can produce various excellent lighting effects resembling kaleidoscope, starry night, icing-cloud, firing-cloud and so forth.

In one embodiment, the lighting module 6 has a memory function, such that when the projector lamp 100 is reenergized after a power interruption, the light emitted through said opening 120 is identical with that before the power interruption.

In one embodiment, the adjusting assembly 9 can alternatively be located remote from the hollow lamp housing 12. For example, the adjusting ring 91 is not disposed on the lamp housing, but on a wall or a console remote from the lamp housing 12 and easy to operate. In this case, the lighting mode of the projector lamp 100 can be adjusted by adjusting the adjusting ring 91 at an appropriate position remote from the projector lamp 100.

The projector lamp can further be applied independently or in combination for many extension indoor or outdoor products. For example the projector lamp can be independently used as a stage lamp, or applied as street lamps, or in inflatable costumes, be applied for forming a dynamic cloud effect, or be embedded inside various cartoon characters or any other suitable objects to realize various shining effects. For example, the projector lamp can be mounted inside a lamp enclosure with translucency or semi-translucency yielding outwardly projects patterns or rear projected patterns upon the enclosure. The projector lamp can be mounted inside inflatable costumes of different shapes or other objects.

With such a projector lamp, LED light beams of different colors can be refracted by multiple lens and multiple refracting surfaces to form colorful light. The combined lights will produce converging light of various angles to project out from the lens, by means of the integral beam-splitter lens formed by multi-angle refractive convex-lenses, such as forming lighting effects resembling colorful clouds. Rotating the lenses will further produce dynamic colorful cloud effect. Beam-splitter lenses of different shapes and different positions and LEDs of different colors will produce different lighting effects.

Though the present disclosure has been illustrated and discussed with the exemplary embodiments which are deemed the most practical ones, the inventions of the present application can be embodied in other suitable forms. The embodiments of the present application are thus exemplary, but not limiting in any manner. The scope of the present application is indicated by the appended claims, rather than the previous description, and all the changes or equivalences falling within the scope of their meanings and ranges are all deemed within the protection scopes.

1. A projector lamp, comprising:
a hollow lamp housing, having an opening formed at a first end thereof;
a power supply adaptor, mounted within said lamp housing and in communication with an external power supply via a second end of said lamp housing;
a lighting module mounted within said lamp housing, having:
a circuit board electrically connected with said power supply adaptor; and
a plurality of light emitting diode units electrically mounted on said circuit board to emit light when said projector lamp is energized;
a lens, mounted at the opening of said lamp housing, the light emitted by said plurality of light emitting diode units projecting out therethrough;
an adjusting assembly, having:
an adjusting ring, mounted on the outer periphery of said lamp housing around a longitudinal axis of said lamp housing extending from the first end to the second end thereof, and rotatable around said longitudinal axis; and
a controller, mounted within said lamp housing, and electrically connected with said lighting module and coupled to said adjusting ring, said controller being capable of adjusting the lighting mode of said plurality of light emitting diode units in response to the rotation of said adjusting ring.

2. The projector lamp of claim 1, wherein said adjusting assembly further comprises an adjusting lever disposed between said adjusting ring and said controller and engaged with them, the rotation of said adjusting ring inducing the motion of said adjusting lever, thereby actuating a controlling switch disposed on said controller.

3. The projector lamp of claim 1, wherein said adjusting ring is rotatable in both directions around said longitudinal axis.

4. The projector lamp of claim 3, wherein said adjusting lever comprises a first side leg, a second side leg and an intermediate leg, said first side leg and second side leg being symmetrical with respect to said intermediate leg, and said adjusting lever pivotably mounted on the inner wall of said lamp housing between said first side leg and second side leg at a first end of said intermediate leg, such that said adjusting lever can pivot around an adjusting pivot parallel to the longitudinal axis of said lamp housing; wherein said first side leg and second side leg can be engaged with a first controlling switch and second controlling switch of said controlling switch, respectively, and a second end of said intermediate leg protrudes through a slot formed in the wall of said lamp housing, so as to engage said adjusting ring;
wherein the rotation of said adjusting ring actuates the second end of said intermediate leg, causing said adjusting lever to pivot around said adjusting pivot, making said first side leg or second side leg actuate said first controlling switch or second controlling switch of said controller.

5. The projector lamp of claim 4, wherein said adjusting ring comprises a plurality of protrusions disposed on the internal periphery thereof and spaced apart from each other; wherein when said adjusting ring is rotated, said plurality of protrusions will contact the second end of said intermediate leg sequentially, actuating the pivotal movement of said adjusting lever.

6. The projector lamp of claim 5, wherein said adjusting ring is disposed in a recess formed on the outer periphery of said lamp housing, with the outer periphery of said adjusting ring and the outer periphery of said lamp housing forming a substantially continuous and smooth outer surface.

7. The projector lamp of claim 6, wherein the outer periphery of said adjusting ring is provided with surface features for the ease of grasping.

8. The projector lamp of claim 1, wherein said adjusting ring is mounted between the opening of said lamp housing and said lens.

9. The projector lamp of claim 1, wherein a metallic Screw-type lamp base is sealingly mounted at the second end of said lamp housing.

10. The projector lamp of claim 9, wherein it further comprises a water tight seal mounted between said adjusting assembly and said lamp housing, and a water tight seal mounted between said lens and the opening of said lamp housing.

11. The projector lamp of any of claim 1, wherein said projector lamp further comprises:
a motor mounted within said lamp housing at a side of said lighting module distal from said opening, said motor being electrically connected with said power supply adaptor and having a motor shaft extending towards said opening; wherein said circuit board has a circuit board opening, said motor shaft passing through said circuit board opening without contacting said circuit board; and
a multi-surface refractive lens secured around said motor shaft and located between said lighting module and said opening within said lamp housing, said multi-surface refractive lens having a plurality of multi-angle refractive convex-lenses formed on a surface of said multi-surface refractive lens distal from said lighting module.

12. The projector lamp of claim 11, wherein the projector lamp lens is a beam-splitter lens, and has a plurality of multi-angle refractive convex-lenses formed on a surface of said beam-splitter lens facing said multi-surface refractive lens.

13. The projector lamp of claim 12, wherein said beam-splitter lens is a semispherical beam-splitter lens.

14. The projector lamp of claim 11, wherein it further comprises an insulating panel mounted between said lighting module and said motor, said insulating panel having a panel orifice, said motor shaft passing through said panel orifice without contacting said panel orifice.

15. The projector lamp of claim 1, wherein said lighting module has a memory function, such that when the projector lamp is reenergized after a power interruption, the light emitted through said opening is identical with that before the power interruption.

16. The projector lamp of claim 1, wherein the lightness and light color characteristics of said projector lamp can be adjusted via the rotation of said adjusting ring.

17. A projector lamp, comprising:
a hollow lamp housing, having an opening formed at a first end thereof;
a power supply adaptor, mounted within said lamp housing and in communication with an external power supply via a second end of said lamp housing;
a lighting module, mounted in said lamp housing and having:
a circuit board electrically connected with said power supply adaptor; and
a plurality of light emitting diode units electrically mounted on said circuit board to emit light when said projector lamp is energized;
a lens, mounted at the opening of said lamp housing such that the light emitted by said plurality of light emitting diode units projects out therethrough;
an adjusting assembly, having:
an adjusting ring operable to be rotated; and
a controller, coupled to said lighting module and said adjusting ring in a wired or wireless manner, said controller being capable of adjusting the lighting mode of said plurality of light emitting diode units in response to the rotation of said adjusting ring.

18. The projector lamp of claim 17, wherein said adjusting assembly is located remote from said hollow lamp housing.
